(19) United States
(12) Patent Application Publication
(10) Pub. No.: US 2010/0121977 A1
(43) Pub. Date: May 13, 2010

(54) Predictive Bit-Rate Modification of Content Delivery in a Wireless Network

(75) Inventors: Kalervo Kontola, Tampere (FI); Miska Hannuksela, Ruutana (FI); Igor Curcio, Tampere (FI); Vinod Malamal-Vadakital, Tampere (FI)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 12/267,814

(22) Filed: Nov. 10, 2008

(51) Int. Cl. G06F 15/16

(52) U.S. Cl. 709/232

(57) ABSTRACT

A sender in a wireless network may adjust the encoding bit rate of the transmitted content and/or the transmission bit rate of the content based on the predicted future channel throughput at a predicted future geographical position of a client mobile device, such as a cellular telephone. By appropriately adjusting the bit rate prior to the client mobile device experiencing the predicted low throughput, the likelihood of continuous content consumption by the client mobile device, even while experiencing the predicted low throughput conditions, may be increased. The prediction may be performed at the network side and/or at the client mobile device side.

### BACKGROUND

In designing a wireless communications network, one typically takes into account a variety of factors, such as selection of supported protocols and transmission technologies, topological design, (e.g., defining the physical locations of network components such as wireless base stations), performance requirements of the network, and financial budget. In practice, such network planning factors may lead to one or more trade-offs. For instance, network performance and financial budget are usually inversely related. In a process of designing a wireless network, network planning factors may be iteratively modified until satisfactory network characteristics are achieved.

Therefore, trade-offs between performance and allowed cost typically exist. For example, network performance may be designed to be relatively high in areas with a high population density and relatively low in less populated areas. It may also be costly to provide high network performance in certain locations such as inside tunnels and in mountainous areas. In such regions, the propagation of signals emanating from base stations is usually constrained by physical obstacles. Obstacles may, for example, prevent signals from reaching some regions or may degrade signal power to those regions. Therefore, client mobile devices, such as cellular phones, accessing the network may experience regions with low or nonexistent network signal coverage. In no- or low-coverage regions, the wireless network service is either substantially unavailable or working at a reduced quality, e.g., lower bit rate and/or relatively high bit error rate, than what may be otherwise provided in regions with relatively good network coverage. Furthermore, the capability of sub-networks or the network infrastructure, such as base stations, may differ. For example, a part of the network may support GPRS (General Packet Radio Services) data connection while another part of the network may support UTRAN (Universal Mobile Telecommunication System Terrestrial Radio Access Network). Therefore, the throughput available for client mobile devices may vary greatly depending on the geographical location and capacity of the devices.

### SUMMARY

Various aspects as described herein are directed to using network connection quality information together with location information to potentially improve content delivery in a wireless network. For instance, the sender in the network may adjust the encoding bit rate of the transmitted content and/or the transmission bit rate of the content based on the predicted future channel throughput at a predicted future geographical position of a client mobile device (such as a cellular telephone). By appropriately adjusting the bit rate prior to the client mobile device experiencing the predicted low throughput, the likelihood of continuous content consumption by the client mobile device, even while experiencing the predicted low throughput conditions, may be increased. The prediction may be performed at the network side and/or at the client mobile device side.

According to further aspects, network coverage quality information may be collected and stored to create and update a network outage database that tracks the geographical locations of various network outage regions in which network signal coverage is either reduced or substantially nonexistent. The data in the database may reflect pre-known network outage regions, as well as new or modified network outage regions as experienced and indicated by various client mobile devices actually using the network in those locations.

These and other aspects will be described with reference to various examples in the Detailed Description section below.

### BRIEF DESCRIPTION OF THE DRAWINGS

A more complete understanding of the present disclosure and the potential advantages of various aspects described herein may be acquired by referring to the following description in consideration of the accompanying drawings, in which like reference numbers indicate like features, and wherein:

FIG. 1 is a functional block diagram of an illustrative system comprising a wireless network and a plurality of client mobile devices;

FIG. 2 is a functional block diagram of an illustrative embodiment of a client mobile device;

FIG. 3a is a flow chart showing illustrative actions performed by a client mobile device during interaction with a network;

FIG. 3b is a flow chart showing illustrative actions performed by the network of FIG. 3a during interaction with the client mobile device of FIG. 3a;

FIG. 4a is a flow chart showing another set of illustrative actions performed by a client mobile device during interaction with a network;

FIG. 4b is a flow chart showing illustrative actions performed by the network of FIG. 4a during interaction with the client mobile device of FIG. 4a;

FIG. 5 is a set of graphs showing illustrative bit rates and buffer status over time as a client mobile device experiences a network outage region, in which bit rates are not modified prior to entry into the network outage region;

FIG. 6 is a graph (not necessarily to scale) showing an example of how transmission bit rate may be modified responsive to predicting that a client mobile device will enter a known network outage region;

FIG. 7 is a set of graphs (not necessarily to scale) showing an example of how encoding bit rate may be modified responsive to predicting that a client mobile device will enter a known network outage region;

FIG. 8 is a set of graphs (not necessarily to scale) showing an example of how transmission bit rate may be modified responsive to predicting that a client mobile device will enter a known network outage region;

FIG. 9 a set of graphs (not necessarily to scale) showing an example of how bit rates may be modified responsive to predicting that a client mobile device will enter a known network outage region that provides a reduced but non-zero data throughput;

FIG. 10 shows an illustrative two-actor architecture for interaction between one or more client mobile devices and a wireless network;

FIG. 11 shows another illustrative two-actor architecture for interaction between one or more client mobile devices and a wireless network;

FIG. 12 shows an illustrative three-actor architecture for interaction between one or more client mobile devices and a wireless network

FIG. 13 shows another illustrative three-actor architecture for interaction between multiple client mobile devices and a wireless network;

FIG. 14 shows another illustrative three-actor architecture for interaction between one or more client mobile devices and a wireless network; and

FIG. 15 shows another illustrative three-actor architecture for interaction between one or more client mobile devices and a wireless network.

FIG. 16 is a functional block diagram of an illustrative embodiment of a streaming server.

### DETAILED DESCRIPTION

The consumption of media content, while the media content data is being streamed, may undergo degradation in rendering quality due, for example, to degradation in data streaming. A client mobile device, for example, may enter a low network coverage, or no coverage, region while the device being in the midst of receiving and rendering a multimedia file such as a video or audio stream. A file that is received using standard streaming or progressive download techniques may be rendered at the client device prior to the file being entirely received. For a client mobile device experiencing low network coverage, e.g., low network signal or low network performance, streaming, or progressive download, may be, for example, temporarily interrupted, rendering quality may be degraded and/or media data may become more error-prone. Such problems may occur even though streamed media file data may be partially locally buffered at the client mobile device. For instance, the amount of locally buffered data may not be enough to provide real-time rendering throughout the period that the client mobile device is located in a region experiencing low network coverage.

The existence of low network coverage, or no-coverage, regions may be unavoidable. However, it is desirable to reduce or even avoid the inefficiencies and inconveniences to network clients in those regions. Certain techniques have been attempted in order to partially compensate for these issues over very short times, such as maintaining a high occupancy level in an extra large client buffer to smooth away minor variations in data delivery rates, and implementing error concealment techniques to reduce visual or audible quality degradation. However, these techniques are inefficient or are effective only in limited situations.

In a region experiencing low or nonexistent network coverage, referred to hereinafter as a “network outage region”, a wireless service may be either totally unavailable or may be working at a lower quality than outside of the network outage region. This means that the streaming receiver buffer of a receiving client mobile device may not receive content (e.g., media) data at a sufficient rate. Thus, if the client mobile device remains in the network outage region long enough, the buffer of the client mobile device may eventually become empty of content, and thus the content may no longer be able to be rendered to the user as intended. In the long term this kind of phenomenon may result, for example, in interruptions in the audio/video playback, freezing picture, worsened quality, continuous re-buffering, and/or the like. Even if content is downloaded for rendering once the download is complete, downloading may be seriously affected in a network outage region until good connection quality is re-established. Degradation in streaming and/or rendering quality may also take place if a network connection becomes disconnected or reduced temporarily while a client mobile device is sending content upstream to the network. The quality of user experience, e.g., in downstreaming and/or upstreaming mode, may be seriously decreased in a network outage region.

Some network outage regions may be relatively small, such as a dead spot between two buildings. In a small network outage region, the reduced or nonexistent data connection, generically referred to herein as an “outage”, experienced by the client mobile device may be short in duration, for example if the client mobile device is moving quickly in a vehicle. Short outages in duration may also result from cell handovers, wherein the base station transmitting to a client mobile device changes due to the movement of the client mobile device from the coverage area of one base station to another. Other network outage regions may be relatively large, such as a valley between two mountains, a tunnel, a portion of a road, highway or railway located far away from residential areas, and/or the like. For example, some existing tunnels may be nearly twenty-five kilometers (km) long. Even if a client mobile device is traveling, for example in a vehicle traveling through the tunnel at seventy kilometers per hour (km/h), the outage may be expected to last more than twenty minutes. Whether in tunnels, on highways, on railroads, and/or the like, it is not unusual, in general, for a client mobile device to be situated in a network outage region for a relatively long time duration. Ironically, network outage regions (such as tunnels) may often be situated in locations considered boring to passengers, and there may actually be an increased demand in network outage regions for network services and other content, e.g., music, video clips, and/or the like. Network outages may be especially disturbing to a user that travels through a network outage region regularly, e.g., during a daily commute.

When content data is sent downstream to a client mobile device, for example, while traveling through a network outage region, the received bit rate due to the outage may decrease and even go to zero. Due to the decrease in bit rate, a streaming receiver buffer, also referred to as the pre-decoder buffer, of the client mobile device may receive less content data than the renderer, e.g., multimedia player, of the same device consumes. Depending on data throughput, streaming buffer size, used encoding bit rate, and/or the like, if the duration of the network outage period is long enough, all the content data stored the buffer may be consumed, e.g., before streaming quality is again restored, and resulting, for example, in rendering interruptions.

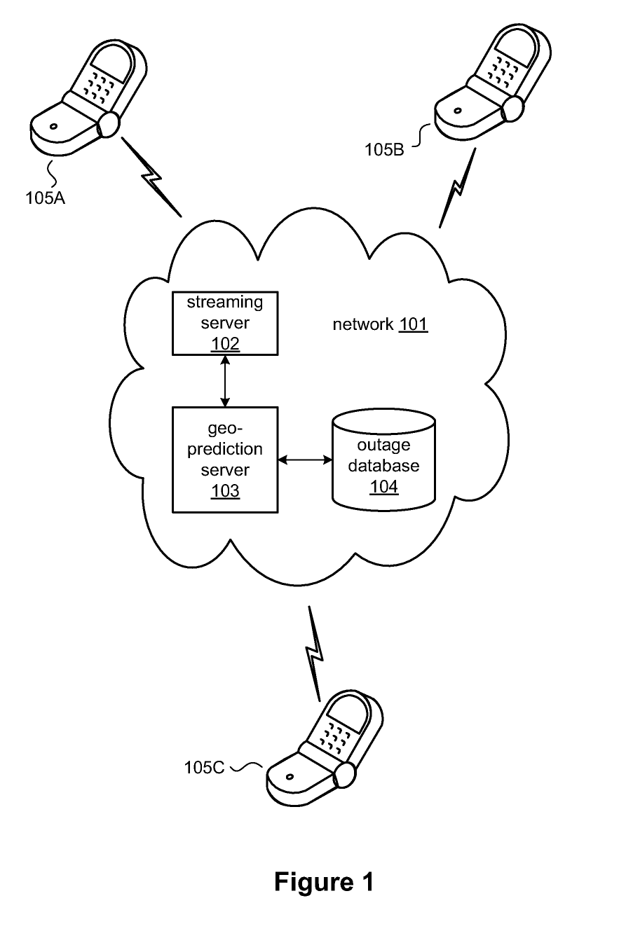

FIG. 1 is a diagram of an illustrative wireless network system, comprising a network 101 and a plurality of client mobile devices 105A, 105B, 105C. Although three client mobile devices 105 are shown, any number of client mobile devices may simultaneously communicate with network 101. For simplicity, any given one of client mobile devices 105A, 105B, 105C will be referred to herein as simply client mobile device 105. If a particular one of the client mobile devices is intended, then it will be specified as such. Network 101 may also comprise one or more wireless base stations, not shown in FIG. 1, for wireless communication with client mobile devices 105.

Client mobile device 105 may be any mobile device that is capable of wirelessly communicating data with network 101. Examples of client mobile device 105 comprise a cellular telephone, a personal digital assistant (PDA), a laptop computer, a palmtop computer, a computer permanently or temporarily installed in a vehicle such as an automobile or airplane, and/or the like. As will be discussed further, client mobile device 105 may comprise network communication functionality, as well as self-location functionality, e.g., using the global positioning system (GPS).

Network 101 may be any type of wireless communication network. Examples of network 101 comprise a cellular telephone network, or a wireless local area network (WLAN), and/or the like. Network 101, as shown in FIG. 1, comprises a streaming server 102, a geo-prediction server 103, and an outage database 104. In the example embodiment of FIG. 1, servers 102 and 103 are illustrated as separate servers. In another example embodiment, streaming server 102 and geo-prediction server 103 may be functional blocks irrespective of their physical embodiments. For instance, the functions of servers 102 and 103 may be embodied in a single computer server or distributed amongst multiple computer servers. Moreover, while servers are discussed, any type of computers may be used. While servers 102 and 103 and database 104 are illustrated to be part of network 101, network 101 may be connected to another communication network or networks, such as the Internet. Servers 102 and 103 as well as database 104 may also be connected to the communication network or networks connected with network 101.

The servers or other computers embodying functional blocks 102 and 103 may comprise both hardware and software. The software may be stored on a computer-readable medium, which may be part of or coupled to servers 102 and 103, in the form of computer-executable instructions. The servers 102 and 103 may read those computer-executable instructions, and in response perform various steps as defined by those computer-executable instructions. In an example embodiment, functions attributed to servers 102 and/or 103 as described herein may be implemented as computer-executable instructions read and executed by the corresponding server(s), and/or by hardware, e.g., a processor, a chip, and/or the like, integrated in, or coupled to, one or more network elements of network 101.

According to an example embodiment, outage database 104 is configured to store outage data in a computer-readable medium. A computer-readable medium may comprise, for example, one or more hard drives, on-chip memories, memory cards, compact disks, and/or the like. The outage data describes or otherwise represents information about one or more network outage regions. In an example embodiment, outage database 104 may be a conventional database, e.g., an Oracle database a structured query language (SQL) database, and/or the like. In another example embodiment, the outage data may be organized, stored, and/or managed in any manner desired, regardless of whether it is formatted as or accessed by a conventional database. For example, outage data may be stored as one or more maps indicating network signal coverage and/or network performance in each region on the one or more maps.

The outage data may comprise information about various network outage regions. This data may be pre-stored and/or may be dynamically updated through the collection of additional data. The additional data may be collected from, e.g., one or more of client mobile devices 105. The additional data may also be collected by the network provider, for example, as part of testing the quality of service provided to its network customers or users. The outage data may comprise, for example, indications of, and/or information about, locations of various network outage regions, as well as their sizes and boundaries. The outage data may also comprise an indication of, and/or information about, various network signal coverage factors associated with each network outage region. Network signal coverage factors may comprise, for instance, instantaneous throughput bit rate of data sent through network 101, average throughput bit rate of data through network 101, packet loss rate, block error rate (BLER), average packet delay, signal strength, and/or the like. In an example embodiment, average throughput bit rate of data may be computed within a pre-defined and/or selected time window. The outage data may further comprise a summary indication for at least one network outage region. A summary indication may be a scale, e.g., from zero to one hundred, of the network signal coverage expected in a network outage region. The summary indication may also be generated based upon a combination of factors comprising one or more of the above-mentioned network signal coverage factors.

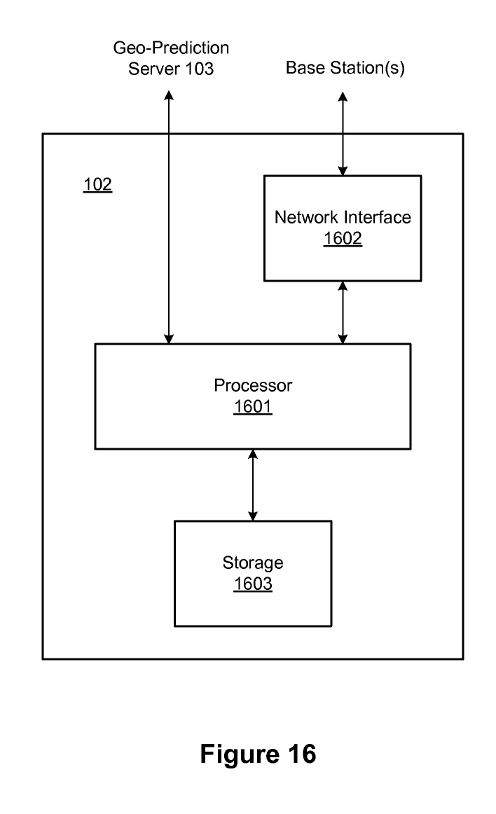

FIG. 16 shows an illustrative embodiment of streaming server 102. In the embodiment of FIG. 16, streaming server 102 comprises a processor 1601, a network interface 1602, and storage 1603. Each functional block may or may not be associated with a separate physical unit. Also, one or more of the functional blocks may be combined into a single physical unit, such as a single semiconductor chip. In addition, the connections between the functional blocks are merely illustrative. As an alternative example, a common bus-type interconnection system may be used. In addition, while the example of FIG. 16 is directed specifically to streaming server 102, the functional blocks shown in FIG. 16 may also encompass or otherwise be applicable to the operation of geo-prediction server 103.

Processor 1601 may comprise, for instance, one or more microprocessors, internal memory, and/or other type of control circuitry. Processor 1601 may be configurable based on computer-executable instructions stored in storage 1603. Storage 1603 may be any type of computer-readable medium such as one or more memory chips and/or hard drives. Functions attributed to streaming server 102, as described herein, may be implemented as computer-executable instructions read and executed by processor 1601. Processor 1601 may also be directly or indirectly coupled with geo-prediction server 103. Alternatively or additionally, another portion of streaming server 102 may be coupled with geo-prediction server 103.

Network interface 1602 may comprise or be coupled to a receiver and/or a transmitter, such as one or more base stations of network 101, for communicating wirelessly with client mobile device 105. The wireless communication may use any protocol or standard, such as but not limited to global system for mobile (GSM) or code division multiple access (CDMA).

Storage 1603 may be any type of computer-readable medium. Storage 1603 may store data for the operation of streaming server 102, as well as the above-described computer-executable instructions executed by processor 1601. In some embodiments, storage 1603 may function as storage for outage database 104.

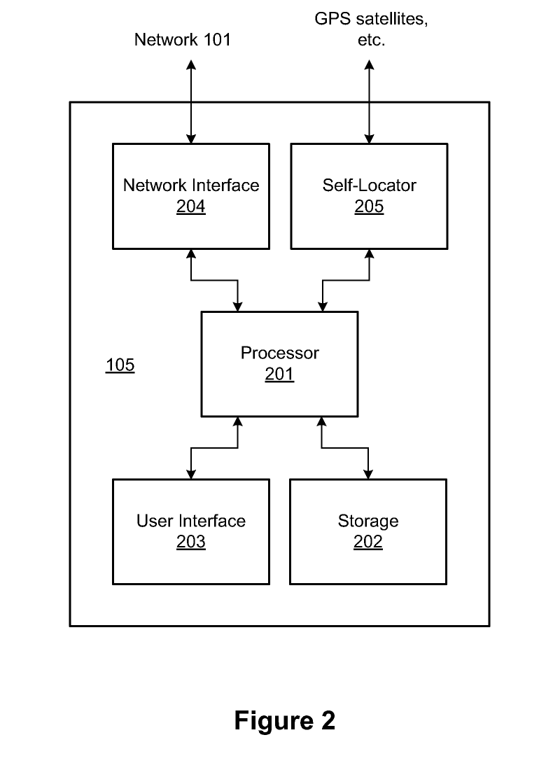

FIG. 2 shows a functional block diagram of an illustrative embodiment of client mobile device 105. In the example embodiment of FIG. 2, client mobile device 105 comprises a processor 201, storage 202, a user interface 203, a network interface 204, and a self-locator 205. Each functional block may or may not be associated with a separate physical unit. Also, one or more of the functional blocks may be combined into a single physical unit, such as a single semiconductor chip. In addition, the connections between the functional blocks are merely illustrative. As an alternative example, a common bus-type interconnection system may be used.

Network interface 204 may comprise a receiver and/or a transmitter for communicating wirelessly with network 101, using any protocol or standard, such as but not limited to global system for mobile (GSM) or code division multiple access (CDMA).

Processor 201 may comprise, for instance, one or more microprocessors, internal memory, and/or other type of control circuitry. Processor 201 may be configurable based on computer-executable instructions stored in storage 202. Storage 202 may be any type of computer-readable medium such as one or more memory chips and/or hard drives. Functions attributed to processor 201, as described herein, may be implemented as computer-executable instructions read and executed by processor 201.

Storage 202 may store data for the operation of client mobile device 105, such as a copy of the outage data or a portion thereof, measured network signal quality readings, one or more maps for use by self-locator 205, and/or any other data as desired. Storage 202 may also comprise a receive buffer for buffering content received from network 101 via network interface 204.

User interface 203 may comprise any input and/or output interfaces accessible by the user of client mobile device 105, such as a keyboard and a display.

Self-locator 205 may perform the function of determining a location, speed, and/or direction of travel of client mobile device 105. This may be accomplished, for example, by using a GPS unit or by triangulation techniques such as by triangulating wireless base stations of network 101.

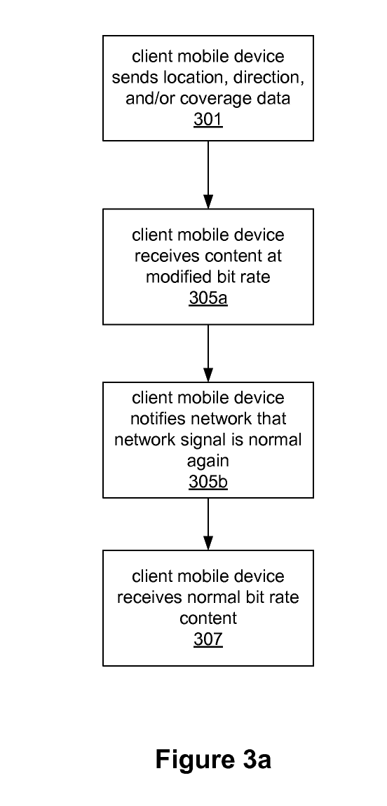

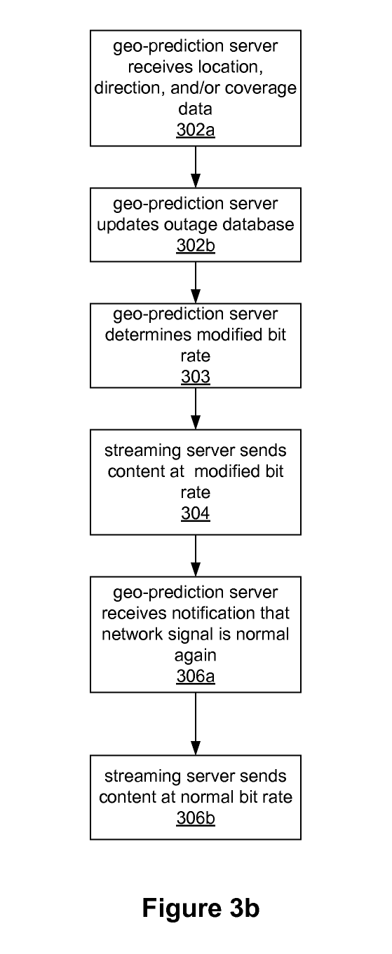

Illustrative operations of a client mobile device 105 and network 101 are described with reference to the flow charts of FIGS. 3a and 3b. Client mobile device 105 may be receiving content, such as streaming multimedia content, e.g., a movie containing audio and/or video content, from streaming server 102. In the example embodiment illustrated in FIGS. 3a and 3b, client mobile device 105 may be moving around while receiving the content. At block 301, client mobile device 105 wirelessly sends, via network 101, updates to geo-prediction server 103. Client mobile device 105 may, for example, send the updates regularly, e.g., periodically. The updates may also be sent, for example, based on a decision made by client mobile device 105 or as a response to a request by network 101. The updates may comprise the current location of client mobile device 105, e.g., GPS coordinates, latitude/longitude, road intersection identification, etc., the current speed of client mobile device 105, the current direction of travel of client mobile device 105, expected future values of any of these, and/or the like. The updates may further comprise network signal coverage data indicating one or more signal quality factors currently being experienced by client mobile device 105 at the current location or at previous locations. For example, each indicated location may be associated with its own signal coverage data.

In response to receiving the update in block 302a, at block 302b geo-prediction server 103 may update the outage data stored in outage database 104 based at least in part on the location and signal coverage data received from client mobile device 105. The updates from client mobile device 105 may allow the outage data to reflect the most recent properties of known outage regions, as well as to add new outage regions and remove defunct outage regions.

As will be described further below in greater detail, geo-prediction server 103 may further determine whether client mobile device 105 will soon enter a known network outage area as indicated by the outage data. If so, then geo-prediction server 103 may determine that a bit rate presently being used to transmit the content to client mobile device 105 should be modified (block 303). Geo-prediction server 103 then signals streaming server 102 to modify the bit rate as appropriate, and streaming server 102 will begin sending content at the modified bit rate (block 304), which will be received by client mobile device 105 at block 305a.

After a while, client mobile device 105 enters the outage region as predicted. In the outage region, client mobile device 105 will receive either a reduced quality network signal or substantially no network signal at all. Thus, content may stop being received in block 304, or at least may be sent at a reduced bit rate while in the outage region. Eventually client mobile device 105 will exit the outage region, such that the network signal will return back to within normal quality range. At that point, client mobile device 105 may sense this and notify (in block 305b) geo-prediction server 103 that the network signal is normal again, and thus that the outage region has been exited. In response to receiving this notification in block 306a, geo-prediction server 103 may notify streaming server 102 to switch back to sending the content at a normal bit rate (block 306b), such as the bit rate achieved prior to modifying the bit rate, or to another bit rate level that may be lower than the modified bit rate, which is received by client mobile device 105 at block 307. Alternatively, geo-prediction server 103 may predict when client mobile device 105 will exit the outage region, and may automatically begin sending content at the normal bit rate. As yet another possibility, geo-prediction server 103 or streaming server 102 may send a query to client mobile device 105, asking whether it has exited the outage region. If client mobile device 105 responds in the affirmative, then block 306b may be performed.

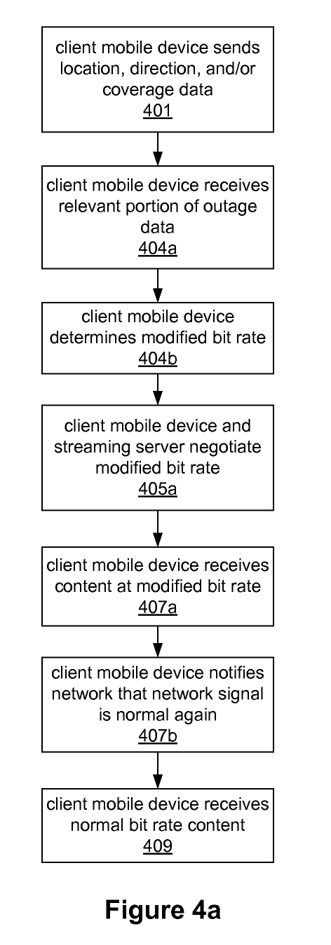

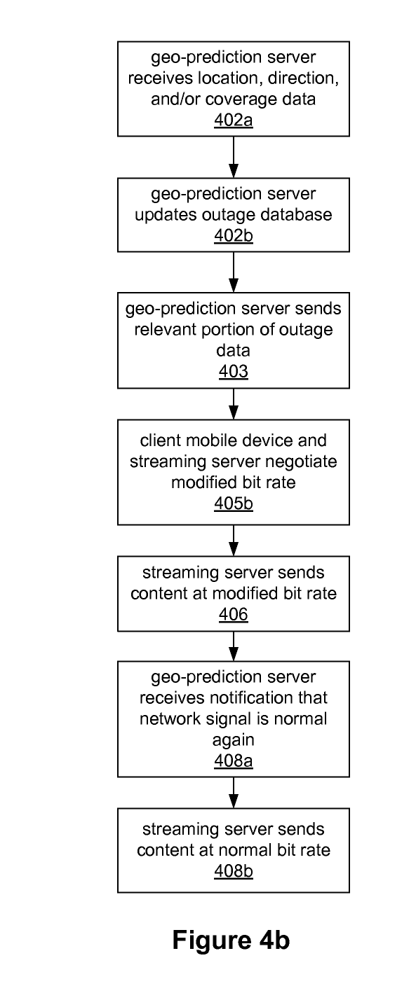

FIGS. 4a and 4b are flow charts of another illustrative embodiment for operation of network 101 and client mobile device 105. In this example, client mobile device 105 locally stores some or all of the outage data in storage 202, and also locally makes a bit rate modification determination. Here, client mobile device 105 sends an update in block 401, in the same manner as block 301. Also, geo-prediction server 103 receives the update at block 402a, and updates the outage data in block 402b in the same manner as in block 302. Then, in block 403, geo-prediction server 103 sends to client mobile device 105 that portion of the outage data that may be relevant to the current or future expected position of client mobile device 105. For example, if geo-prediction server 103 determines that client mobile device 105 is near two particular network outage regions, then geo-prediction server 103 may send outage data for those two network outage regions to client mobile device 105.

Next, in block 404a, client mobile device 105 receives the outage data, and at block 404b client mobile device 105 determines an appropriate modified bit rate based on the outage data. For example, if client mobile device 105 determines that it will soon be entering one of those two network outage regions, then client mobile device 105 may determine that the bit rate should be modified upward prior to entry into the network outage region.

In block 405a, client mobile device 105 requests the modified bit rate, and it along with streaming server 102 in block 405b negotiate a final bit rate, which may or may not be equal to the requested modified bit rate. Once a modified bit rate has been negotiated, streaming server 102 begins sending the content at the negotiated modified bit rate in block 406. Then blocks 407a, 407b, 408a, 408b, and 409 may be performed in the same manner as described above with regard to blocks 305a, 305b, 306a, 306b, and 307, along with the various alternatives to those steps as previously described.

In both of these examples of FIGS. 3 and 4, geo-prediction server 103 performs blocks 302b and 402b responsive to the update received from client mobile device 105 in blocks 302a or 402a. However, blocks 302b and 402b may be performed at any time, irrespective of the updates received from client mobile device 105.

In the next section, examples will be described of how the bit rate may be modified in response to determining that client mobile device 105 is expected to enter an outage region.

### Bit Rate Modification

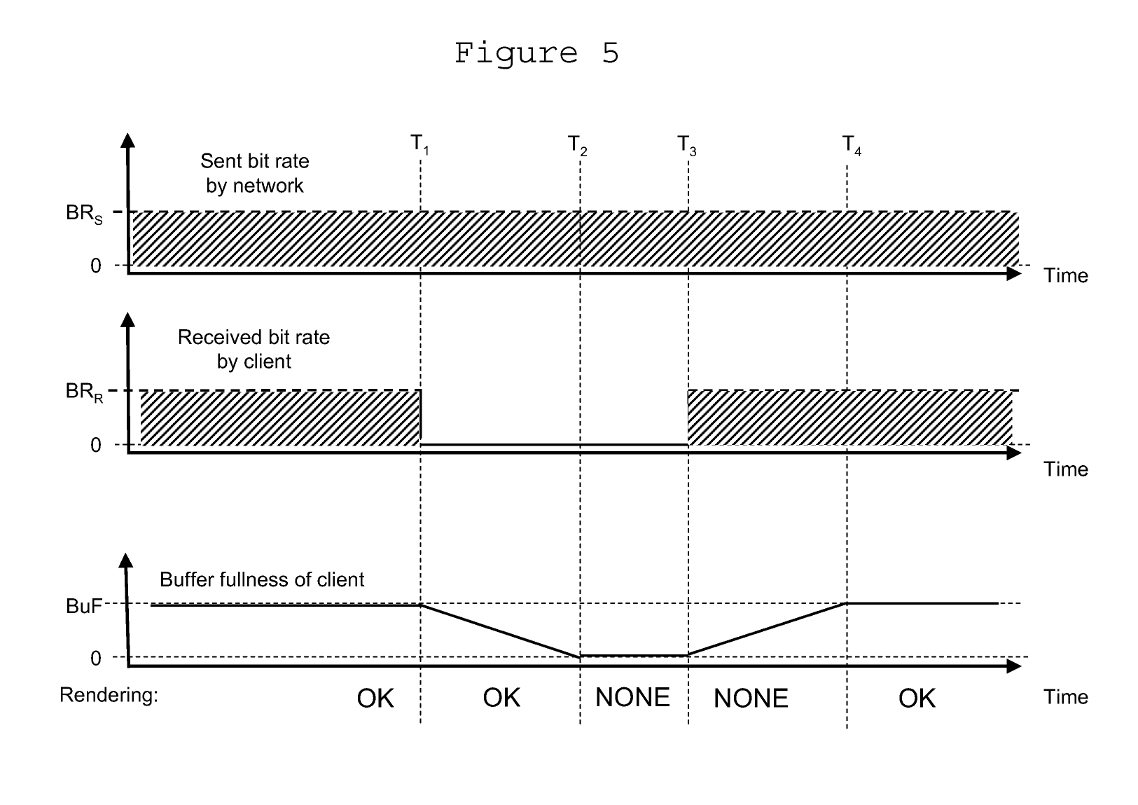

FIG. 5 shows an example of how the bit rate BR_{S} of the content data transmitted by network 101, the bit rate BR_{R} of the content as received by traveling mobile client device 105, the client mobile device receiver buffer (in storage 202) fullness BuF, and the rendering capability of client mobile device 105 conventionally behave when experiencing a network outage region. In this example, streaming server 102 is transmitting content first at bit rate BR_{S} and network 101 is able to deliver the content at that bit rate. The bit rates BR_{S} and BR_{R} are actually somewhat higher than the true encoding bit rate, due to the inclusion of overhead data used for packetization and network settings. In order to simplify the figures, the portion used for overhead is not specified in the figures. The behavior of receiver buffer fullness shows how the fullness value may change over time when the bit rate is adjusted as described. The buffer fullness may be indicated as an absolute or relative value. For example, the buffer fullness value may indicate the absolute buffer size remaining or used (e.g., in bytes), the time period (e.g., in seconds) that content stored in the buffer covers during rendering, or how those values differ when compared to the assumed normal buffer fullness values.

As can be seen from FIG. 5, at first client mobile device 105 has a normal connection in which it is receiving data at the same bit rate, i.e., BR_{R}=BR_{S}. However, client mobile device 105 then enters a tunnel or other type of network outage region at time T₁, at which point client mobile device 105 loses its network data connection. Thus, in this example, BR_{R}=0. Of course, in other examples, BR_{R} may be small but non-zero. After client mobile device 105 has exited the tunnel or other type of network outage region at time T₃, the network connection is normal again.

As shown in FIG. 5, during the time period when client mobile device 105 is not able to receive any data (i.e., from T₁ to T₃), then rendering by the renderer of client mobile device 105 continues normally until the fullness of that receiver buffer goes below a predefined threshold value, which may be zero or non-zero (depending upon how the renderer is configured). In the present example, it will be assumed that the threshold is zero (i.e., that the threshold indicates an empty buffer). That time instant in this example is marked as time T₂. When client mobile device 105 begins again to receive data at time T₃, then the buffer begins to fill once again, and when it is full enough for the renderer (occurring at time T₄), then rendering may begin again. Thus, because client mobile device's buffer in storage 202 does not have enough data during the time period between T₂ and T₄, rendering is not possible during that period.

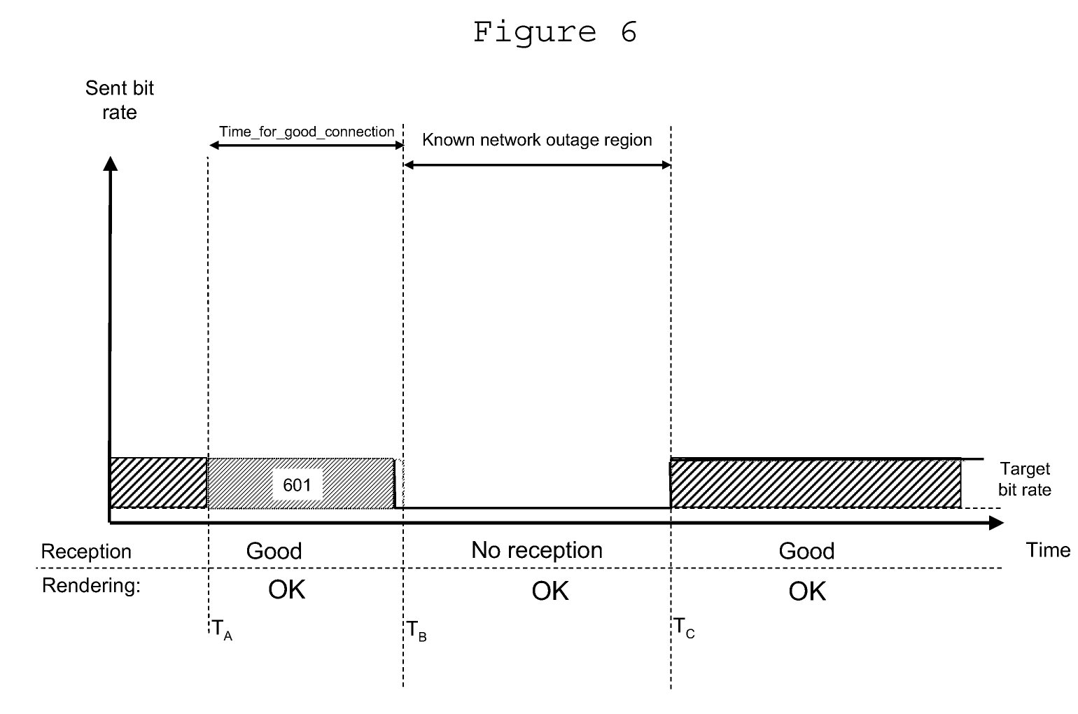

FIGS. 6-9 show various examples of how content may be provided by the network so that the content may be continuously rendered by client mobile device 105, despite the fact that client mobile device 105 may enter a network outage region for an extended period. To do this, a prediction may be made that client mobile device 105 will soon enter the network outage region, and the transmission bit rate may be adjusted accordingly prior to such entry. In this way, the temporary reduced network performance, or even lack of performance, may be transparent to the user of client mobile device 105. The prediction may be made based on information about client mobile device's 105 current location and information regarding known network outage regions. The prediction may be further based on information regarding client mobile device's 105 direction and speed of travel, as well as based on a geographical map of known routes, such as roadways. Details regarding how the prediction may be made will be discussed further below.

FIG. 6 shows an example of a process that may occur when it is predicted that client mobile device 105 is going to enter a known network outage region. At time T_{A} client mobile device 105 predicts that in near future (e.g., after five more km of driving) that it will have, e.g., a two km distance without a network connection (i.e., a two km outage region). Client mobile device 105 is expected to enter the network outage region at time T_{B} and exit the network outage region at time T_{C}. If client mobile device 105 is travelling, for example, at 72 km/h (=20 m/sec) then a value “Time_for_good_connection” (estimated time between T_{A} and T_{B}) is 5000 m/(20 m/sec)=250 sec. If the estimated travelling speed through the network outage region is not expected to change, then the estimated time to be used between T_{B} and T_{C} is calculated as: 2000 m/(20 m/sec)=100 sec. Client mobile device 105 may therefore send, between times T_{A} and T_{B}, a request to network 101 for new streaming parameters. Alternatively, network 101 may independently determine that new streaming parameters are needed, based on location updates from client mobile device 105. At that point, the content is sent (data 601) using the new streaming parameters.

To provide for tolerance for variations in the speed that may occur prior to entering the network outage region, a relatively short safe marginal period may be implemented just before entering, as indicated in FIG. 6 by the gap between a “Time_for_good_connection” period and time T_{B}. After time T_{B} (until Time T_{C}), network 101 no longer sends any content to client mobile device 105 because sending the content would likely be a waste of resources. And, using the techniques as will be discussed further, the receiver buffer (in storage 202) of client mobile device 105 can be expected to already have stored sufficient content to allow for continuous content rendered during the entirety of the period between T_{B} and T_{C}, assuming that the receiver buffer is sufficiently large.

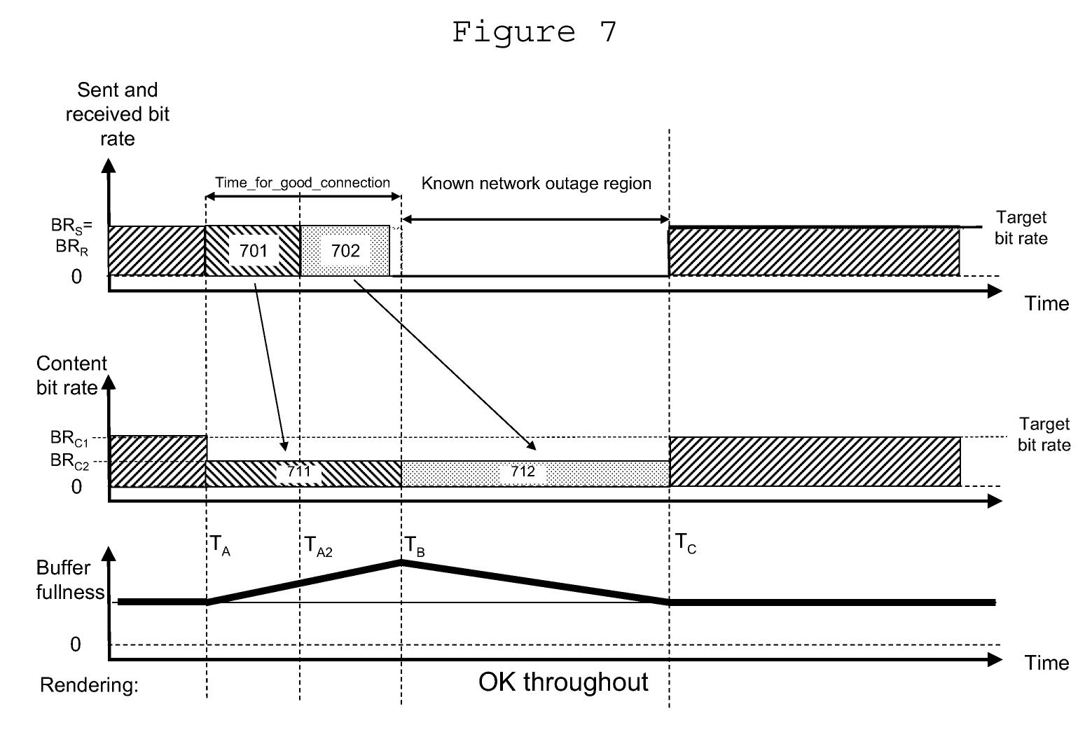

Referring to FIGS. 7-9, the transmission bit rate (BR_{S}), received bit rate (BR_{R}), buffer fullness (BuF), and rendering capability are otherwise as described with regard to FIG. 5, except now both the sent and received bit rates are in the upper part of those figures, and in the middle parts are shown the received encoding bit rate. To clarify, the “transmission bit rate” is the number of bits per unit of time (e.g., per second) that are actually transmitted by network 101 (i.e., by streaming server 102). The “encoding bit rate” is the number of bits per unit of time needed to properly render the content represented by the bits. Also, as with FIG. 5, in these examples the overhead used for content transport is not explicitly shown.

The encoding bit rate may be adjusted by any of several methods while the content is being streamed. For example, if real-time encoding or transcoding of the content is being performed, the bit rate control algorithm of the encoder or transcoder may be configured to output a desired bit rate, such as by modifying the frame rate, the resolution, and/or the like. Stream thinning, stream switching, or both may be applied for pre-encoded content. Stream thinning refers to omission of certain coded data units, such as non-reference pictures and the least important scalability layers, from the transmitted stream. One example of a scalable video codec is the scalable extension of the Advanced Video Coding (H.264/AVC) standard, often referred to as the Scalable Video Codec (SVC). SVC provides temporal, quality, and spatial (picture size) scalability. Even non-scalable video bit streams can be thinned as explained next. A known method in current streaming systems to cope with drastically dropped channel throughput is to transmit intra-coded pictures only. When the network throughput is restored, inter-coded pictures can be transmitted again from the beginning of the next group of pictures (GOP). Generally, any chain of inter-coded pictures can be safely disposed, if no other picture is predicted from them. Consequently, inter-coded pictures at the tail of a GOP can be removed without affecting the decoding of any previous or subsequent picture.

If stream thinning does not provide a wide enough dynamic range for bit rate adjustment, the server may switch to a different version of the bit stream containing the same content but coded for a bit rate that is closer to the network throughput. Switching to a different bit stream can naturally be done at any random access point. In order to respond to a need for adjusting the bit rate to be faster and reduce or even avoid the compression penalty of frequent intra pictures, S frames or SI/SP frames may be used. S frames are inter-coded frames typically used only when switching from a first stream to a second stream. S frames are encoded with a small quantization step and make the decoded S frame close but typically not identical to the corresponding decoded picture of the second stream. The Advanced Video Coding (H.264/AVC) standard comprises the feature known as SI/SP pictures, which can be used similarly to S frames but provide an identical decoded picture after switching compared with decoding of the stream from the beginning. Identical decoded pictures may be obtained with the cost of additional transform and quantization steps in the decoding process for SI/SP pictures both in the primary streams and for SI/SP pictures used for switching only.

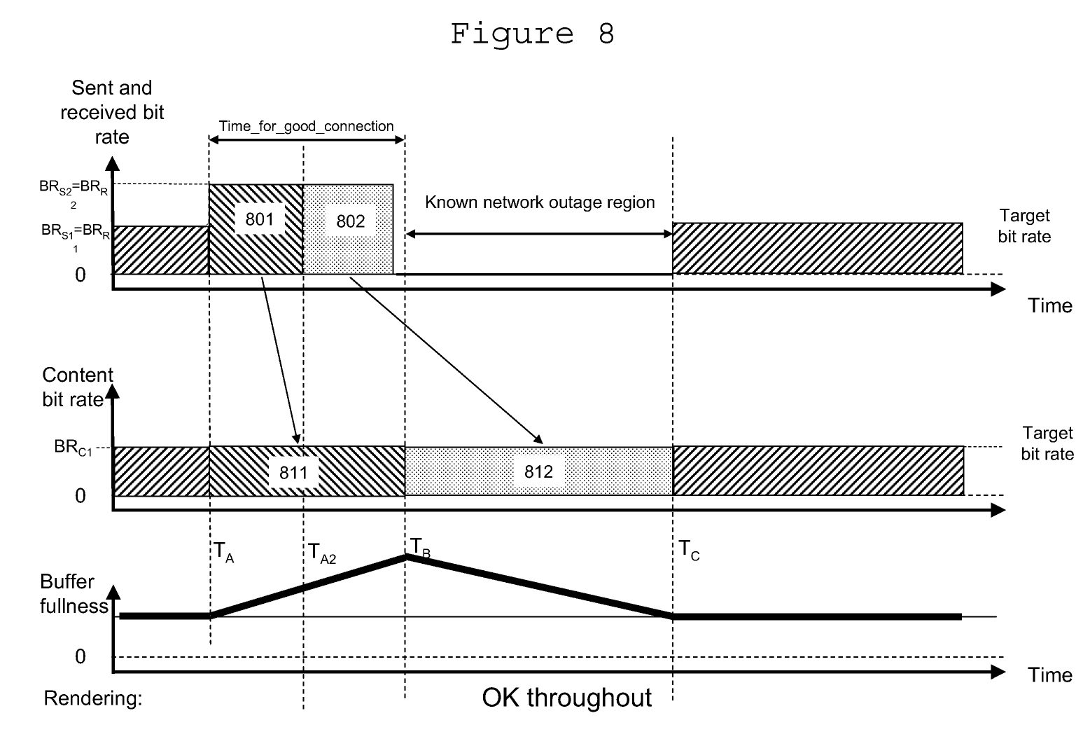

FIGS. 7 and 8 show what may occur, in terms of bit rate, when client mobile device 105 is predicted to soon enter the network outage region. FIG. 7 shows, in particular, an example where network 101 does not allow an increase of the transmission bit rate during the “Time_for_good_connection_period, even when it is predicted that client mobile device 105 will be soon entering the network outage region. To reduce the chances of client mobile device's 105 receive buffer underflowing during the expected outage, streaming server 102 may switch the current content stream to another content stream having a lower encoding bit rate. Thus, for a given transmission bit rate, a time-wise larger amount of content having a low encoding bit rate will be able to be transferred from streaming server 102 to client mobile device 105 in the same amount of time, as compared with content having a higher encoding bit rate but covering a shorter rendering time period.

To have enough channel capacity to send the content that will be consumed while client mobile device 105 is in the network outage region, then responsive to predicting that client mobile device 105 will soon enter the known network outage region, at time T_{A} stream server 102 switches the content stream from a bit stream having a higher encoding bit rate BR_{C1} to another version of the same content in a bit stream having a lower encoding bit rate (BR_{C2}). In that way it may be more likely that client mobile device's 105 receiver buffer will have stored sufficient content to render the content continuously throughout the period between times T_{B} and T_{C}. The size of the needed streaming receiver buffer will be greatest at time T_{B}, because during that time the buffer is expected to contain all of the content needed for rendering during the entire predicted upcoming network outage region. The fullness of the buffer will depend on the applied new transmission and encoding bit rates.

For example, assuming that the initial media encoding bit rate (BR_{C1}) is 256 kbit/sec, that that the time period between times T_{A} and T_{B} is 250 seconds, and that the expected outage between times T_{B} and T_{C} is 100 sec, then during the 250 sec period, content that can be rendered continuously for a total of 350 sec (250+100=350 sec) should be sent prior to time T_{B}. Thus, in the case where a constant transmission bit rate is maintained, then the maximum allowed average encoding bit rate during that whole 350 sec period would be:

average_encoding_bit_rate=250/350*256 kbit/sec=about 182 kbit/sec, this is indicated in FIG. 7 as BR_{C2}.

This would mean that during such 250 sec good connection time (the period between times T_{A} and T_{B}), it would take about 179 sec (the period between times T_{A} to T_{A2}) to send data 701 to be consumed/rendered (data 711) by client mobile device 105 during the “Time_for_good_connection” period, and after that it would take about 71 sec (the period between times T_{A2} and T_{B}) to send data 702 to be consumed/rendered (data 712) by client mobile device 105 while in the outage region (the period between times T_{B} and T_{C}), i.e., it would take a total of 250 sec to send all of this data. On the client side, this means that the content sent during that 179 sec would be consumed/rendered during that 250 sec time period and content sent during the subsequent 71 sec would be consumed/rendered during that 100 sec time period. This means that during the entire expected time within the network outage region, there is expected to be sufficient content stored in the receiving buffer of client mobile device 105. Therefore, the stored content may be continuously consumed/rendered at client mobile device 105 throughout the expected time spent within the network outage region.

In another illustrative embodiment, the approach illustrated in FIG. 7 may be followed except that the encoding bit rate is kept smaller than the transmission bit rate for a certain “fast-startup period” when the outage is over (when time T_{C} has been passed, i.e., from time T_{C} to time T_{D}). For example, the encoding bit rate may be equal to BR_{C2} while the transmission bit rate is equal to BR_{S} in the period of T_{C} to T_{D}. Thus, the buffer fullness in terms of time of buffered media data increases faster than if the transmission bit rate were equal to the encoding bit rate. Responsive to a desired buffer fullness in terms of time of buffered media data being reached at time T_{D}, the encoding bit rate may be adjusted to match the transmission bit rate.

FIG. 8 shows an example in which streaming server 102 increases the transmission bit rate from original BR_{S1} to a higher rate BR_{S2}, and so the received bit rate would also be expected to increase from BR_{R1} to BR_{R2}, correspondingly. Such an increase in the transmission bit rate requires that network 101 is capable of delivering data at the increased transmission bit rate. The encoding bit rate may additionally be decreased. However, if the increase in the transmission bit rate is large enough and/or the expected outage is short enough in time, then simply increasing the transmission bit rate may be sufficient, as is the case in FIG. 8.

When using the example values from above, then now when the expected outage is 100 seconds, the “Time_for_good_connection” period is 250 seconds, and the bit rate of streamed media is again 256 kbit/sec, then client mobile device 105 should ideally receive prior to the outage a total of about 11.2 Mbytes (=350 sec*256 kbit/sec/(8 bits/byte)), of which 8 Mbytes (=250 sec*256 kbit/sec/(8 bits/byte)) is to be consumed/rendered prior to entering the network outage period (i.e., during the “Time_for_good_connection” period) and the remainder (3.2 Mbytes) is to be consumed/rendered during the 100 second network outage period. The earlier streaming server 102 starts sending data at the higher bit rate BR_{S2}, the smaller BR_{S2} needs to be. If it uses that whole 250 seconds, i.e., begins sending at higher bit rate BR_{S2} at time T_{A}, then the bit rate increase (BR_{S2}−BR_{S1}) would be about 102 kbit/sec, i.e., BR_{S2}=11.2 Mbytes/250 sec=about 358 kbit/sec. However, if it takes only, e.g., two minutes (120 sec) (i.e., begins sending at higher bit rate BR_{S2} at time T_{A}+130 sec), then the increase in the bit rate for that period would be higher, about 213 kbit/sec, i.e., BR_{S2}=(11.2 Mbytes−256 kbit/sec*130 sec)/120 sec=469 kbit/sec.

In another embodiment, the approach illustrated in FIG. 8 may be followed except that the transmission bit rate is kept greater than the encoding bit rate for a certain “fast-startup period” when the network outage is over at time T_{C}, i.e., after the timer period from time T_{C} to time T_{D}. For example, the transmission bit rate may be equal to BR_{S2} and the encoding bit rate may be equal to BR_{C1} during the period of T_{C} to T_{D}. Thus, the buffer fullness in terms of the time of buffered media data increases faster than if the transmission bit rate were equal to the encoding bit rate. Responsive to a desired buffer fullness in terms of time of buffered media data being reached at time T_{D}, the transmission bit rate may be adjusted to match the encoding bit rate.

In still another embodiment, the approach illustrated in FIG. 7 or FIG. 8 may be followed except that the transmission bit rate is kept greater than what the encoding bit rate would regularly be and the encoding bit rate is selected to be lower than the transmission bit rate would regularly be for a specified “fast-startup period” when the network outage is over at time T_{C}, i.e., after the timer period from time T_{C} to time T_{D}. For example, the transmission bit rate may be equal to BR_{S2} and the encoding bit rate may be equal to BR_{C2} during the period of T_{C} to T_{D}, and the transmission bit rate may be equal to BR_{S1} (<BR_{S2}) and encoding bit rate equal to BR_{C1} (<BR_{C2}) after T_{D}.

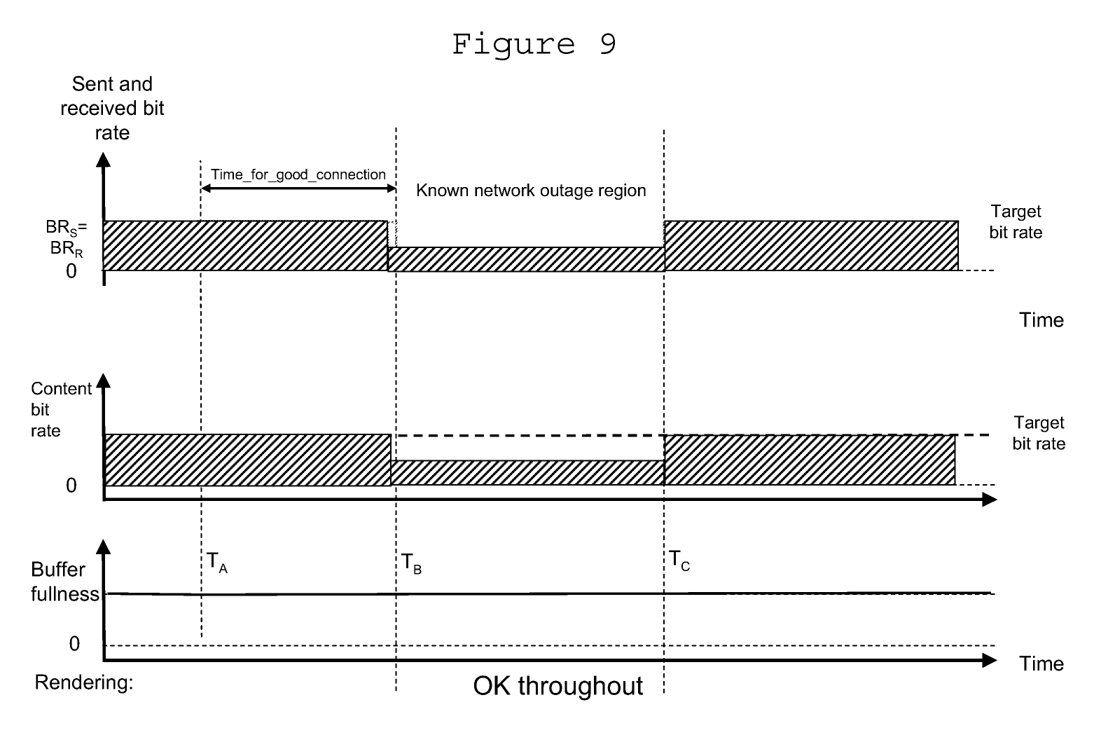

FIG. 9 shows an example in which there is known to be a reduced but non-zero data throughput within a network outage region. Content stream switching may be also used here to lower the encoding bit rate responsive to predicting that client mobile device 105 will soon be entering a network outage region. Additionally or alternatively, the transmission bit rate may be reduced responsive to predicting that client mobile device 105 will soon be entering the network outage region. In this particular example, the lowered transmission bit rate and encoding bit rate begins at time T_{B}. Because one or both of the sent and encoding bit rates are decreased, the buffer fullness at client mobile device 105 may not change in the long run, or at least may be reduced at a rate that is insufficient to empty the buffer prior to the expected exit time from the network outage region. In addition, for this example of any of the other examples herein, the encoding bit rate could be reduced from the initial rate to the target rate in a plurality of smaller sequential steps, which may allow any quality change noticed by the user of client mobile device 105 to be smoother.

In addition to bit rate reduction, streaming server 102 may reschedule data packet transmissions responsive to geo-predictive server 103 predicting impending entry of client mobile device 105 into a network outage region. For example, the data packets may be rescheduled such so that those packets considered to be more important are sent prior to those packets considered to be of less importance. Thus, if the network outage region is entered earlier than expected, while not all of the intended packets would have been received by client mobile device 105, at least the most important packets would have been most likely received. This prioritization process may take into account the estimated amount of bytes available for streaming or other content delivery before the expected lowered encoding bit rate switchover begins. For instance, where the content is encoded by a scalable codec such as scalable video codec (SVC), and if it is not possible to increase the extra bit rate sufficiently prior to entering the network outage region, then network 101 may consider the data for the base layers to be of the most importance, and thus schedule that data to be sent prior to the remaining content data (e.g., enhancement layer data).

### Outage Prediction

As described previously, the transmission bit rate may be adjusted upwards, and/or the encoding bit rate may be adjusted downwards, responsive to predicting or otherwise determining that client mobile device 105 will soon be entering a network outage region. This prediction may be made based on location information that indicates the current or expected future location of client mobile device 105. This location information may further indicate other properties of the client mobile device location and/or movement, such as the current or expected future direction of travel, and/or the current or future expected speed of travel, of client mobile device 105. The location information may be provided by client mobile device 105 on a periodic (regularly or irregularly) basis during travel, or prior to travel.

In some cases, client mobile device 105 may have defined a predetermined navigation route prior to travel, in which case the location information may comprise information about the predetermined navigation route (or individual portions thereof). In these cases, the navigation route may be provided entirely up front (such as prior to the route actually being traveled) to geo-prediction server 103, so that the geo-prediction server 103 has knowledge of the predetermined navigation route. Alternatively, the navigation route may be provided by client mobile device 105 to geo-prediction server 103 in a piecemeal manner during travel.

For example, where client mobile device 105 sends navigation route information prior to or at the beginning of a journey, then the navigation route information may comprise the expected route for K seconds/minutes and/or position points in the future, as well as the expected speed for K seconds/minutes and/or D meters in the future. All units of measure mentioned herein are merely illustrative.

If the route navigation information is sent only at the beginning of or prior to the journey for a whole route, then the size of transferred data may be expected to be quite large in some cases. Also, if the route is changed during travel, then data for the true route would not be available to the network. Thus, it may be desirable to split the navigation route into smaller overlapping or non-overlapping portions and to send the route navigation data for those portions throughout the journey.

Where the route navigation information is sent during the journey, then the following information may be sent to the network from the client mobile device for each local source and destination pair: the expected route for K seconds/minutes and/or position points in the future, and speed information such as the current speed, the expected future speed (for K seconds/minutes and/or position points in the future), and/or historical speed data (for N seconds/minutes and/or position points in the past).

As discussed above, another possibility is that client mobile device 105 will travel without a predetermined navigation route. In that case, client mobile device 105 may send the location information only during the journey. Then geo-prediction server 103 may estimate and predict as to which direction mobile client device 105 will likely travel based on its current location, current speed, and/or expected future speed, as well as available map information on that area known to geo-prediction server 103. For example, if the location of client mobile device 105 has followed a railway track or a highway in the recent past, it is reasonable to predict that client mobile device 105 will continue to follow the same railway track or highway for at least a determined period of time or distance.

The prediction may further be made based on the network signal coverage information indicating the level of network signal quality experienced by client mobile device 105 during traveling.

This location, direction, speed, and/or coverage (for example) information is compared with information regarding a predetermined set of known network outage regions as indicated by the stored outage data. Based on the comparison, it can be determined whether client mobile device 105 is likely to enter one of the known network outage regions, when entry is likely to occur, and when it is likely that client mobile device 105 will subsequently exit the network outage region.

As described previously, the prediction may be made by geo-prediction server 103 or by client mobile device 105. Examples of system architectures that allow for such a prediction to be made by geo-prediction server 103 or by client mobile device 105 are described next.

### Architecture

When content is streamed then there may be three basic functions involved: a streaming function, a streaming client (i.e., the client mobile device), and a geo-prediction function. In various examples to follow, the content streaming function is described as being performed by a streaming server, and the geo-prediction function is described as being performed by a geo-prediction server. However, this is merely illustrative, and these functions may be performed by any one or more servers or other types of computers, and may be even be combined into the same server or other type of computer.

As previously described, geo-prediction server 103 may handle coverage data or geo-prediction algorithms and communicate one or both of those appropriately to the other actors in the system. Furthermore, geo-prediction server 103 can be either interactive or passive. An interactive geo-prediction server continually monitors the geographical position of client mobile device 105 and can dynamically (in real time) compute the coverage data information or the best transmission policies for client mobile device 105. An interactive geo-prediction server may be particularly appropriate for continually changing routes or in the case of varying traffic conditions. When a passive geo-prediction server is used, then the transmission policy may not be easily changed dynamically. Thus the passive geo-prediction server may be better suited for a fixed route travel, such as a train or a long distance city-to-city bus service.

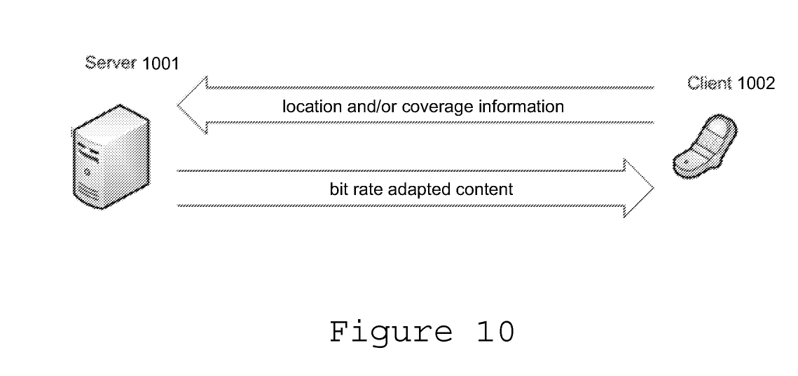

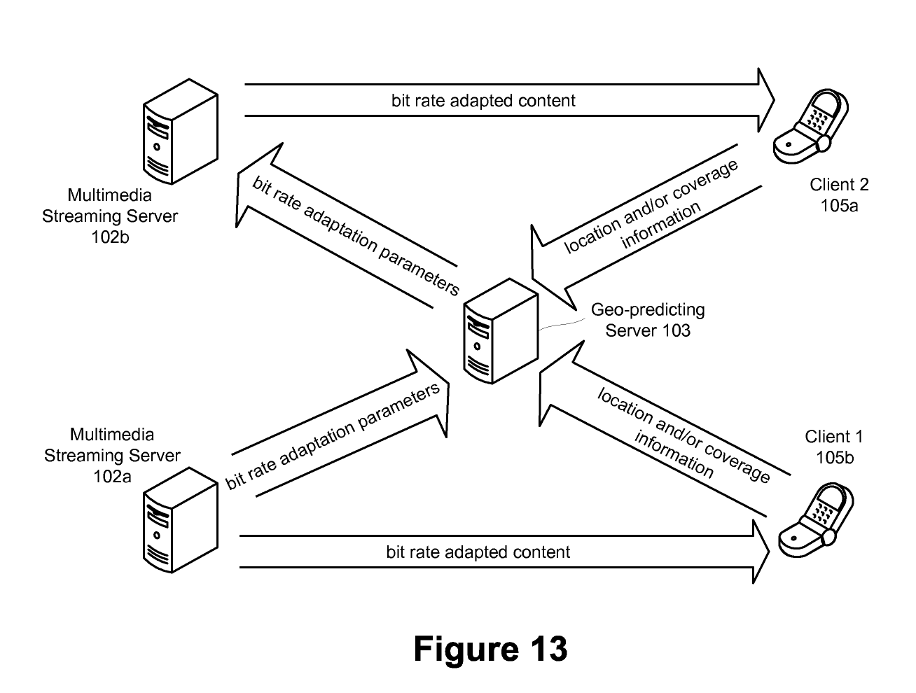

FIGS. 10-15 shows various illustrative architectural implementations of those three basic components. In these figures, only one client (or two clients in the case of FIG. 13) is shown for simplicity. However, it will be understood that in practice the streaming server and the geo-predictive server can support many client mobile devices simultaneously.

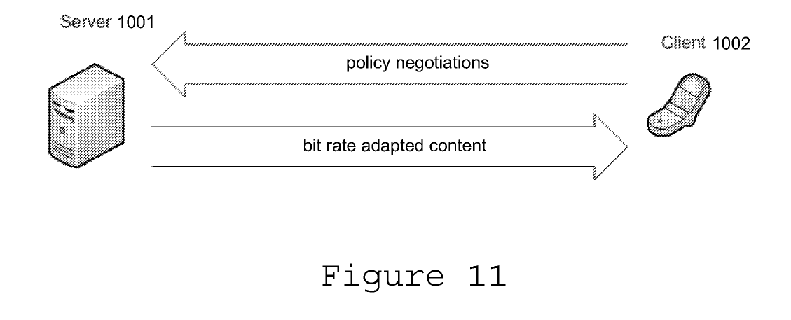

In the two-actor implementations of FIGS. 10 and 11, one actor is a client 1002 (which may be or otherwise comprise client mobile device 105) and the other is a server 1001 (which may be or otherwise comprise streaming server 102 and/or geo-prediction server 103). Thus, such an implementation may be similar to a common server-client model, but with enhanced processing capabilities. The server 1001, apart from being a multimedia streaming server in this example, may also process geographical and reception reports. There are the following possible scenarios for a two-actor implementation based on the selected operation mode (interactive vs. passive) and which one of the actors (either the client 1002 or the server 1001) plays lead role:
Interactive operation mode is used, and the server 1001 plays the lead in geo-prediction (FIG. 10);
Interactive operation mode is used, and the client 1002 plays the lead in geo-prediction (FIG. 11);
Passive operation mode is used, and the server 1001 plays the lead in geo-prediction (FIG. 10); or
Passive operation mode is used, and the client 1002 plays the lead in geo-prediction (FIG. 11)

When the server 1001 plays the lead in geo-prediction, then the server 1001 may have the full support of a multimedia streaming server and a geo-predictive server. The client 1002 may simply send its location information and measured reception data to the server, in addition to normal processing of the content for consumption. The server 1001 calculates streaming parameters directly based on client location and estimated route, and then sends content using those streaming parameters.

Where the client 1002 plays the lead in geo-prediction, then the client 1002 controls what is requested from the server 1001, and the aspect of geo-prediction performed by the server 1001, if any, may be limited to simply storing and accessing a database for use with the measured reception data. The server 1001 responds by following up with the requests made by the client 1002 based on geo-prediction results determined independently by the client 1002.

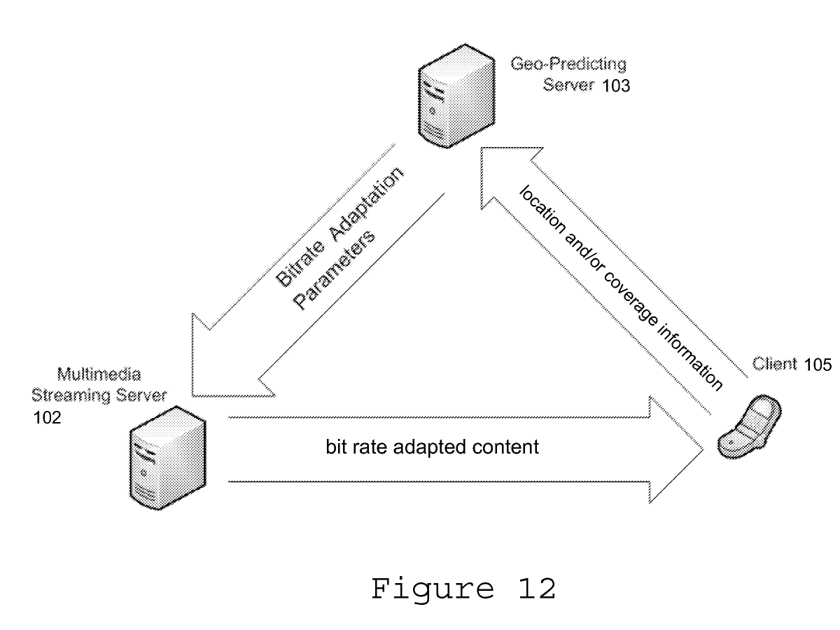

In the three-actor configurations of FIGS. 12-15, geo-predicting server 103 is a separate functional and logical unit from streaming server 102. However, physically those two servers can be either in the same or in different locations and/or be implemented by the same physical server or other type of computer. Possible scenarios in a three-actor configuration comprise:

(1) In an example shown in FIG. 12, geo-prediction server 103 is connected both to streaming server 102 and the client mobile device 105. In this example, the client mobile device 105 sends its navigation route or segment thereof (or its current location) and associated measurement data to geo-predictive server 103. As appropriate, geo-prediction server 103 predicts the upcoming route of client mobile device 105. Then, geo-prediction server 103 calculates suitable streaming parameters and sends a request to streaming server 102. Based on the requested streaming parameters, streaming server 102 delivers content data to the client mobile device 105. FIG. 13 is an extension of FIG. 12. In FIG. 13, a single geo-predicting server 103 serves two separate streaming servers 102a, 102b and two client mobile devices 105a, 105b.

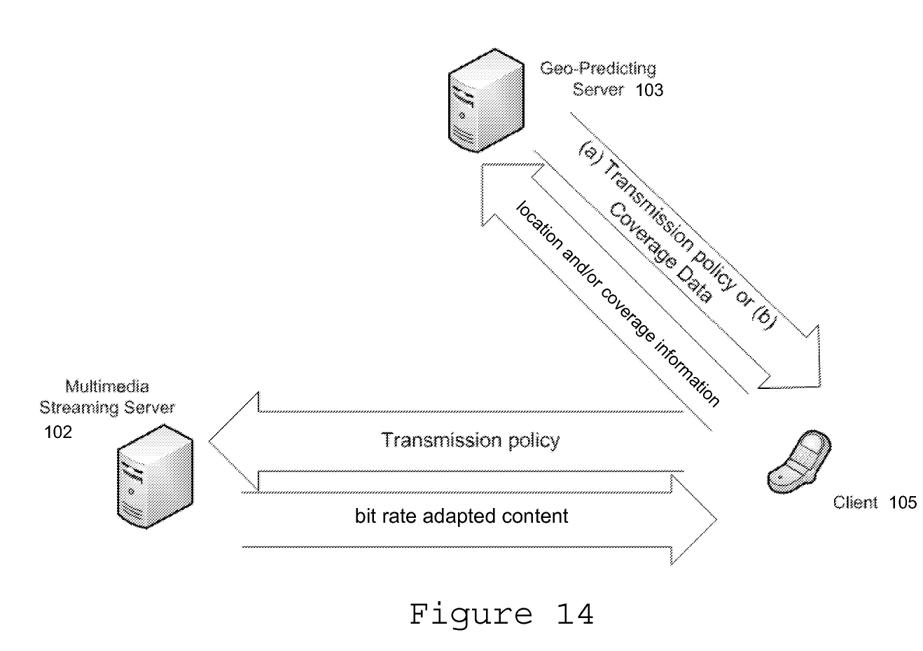

(2) In another example shown in FIG. 14, geo-prediction server 103 is connected to client mobile device 105, and geo-prediction server 102 handles adaptive bit rate control. In this example, client mobile device 105 sends its navigation route or segment thereof (or its current location) and associated measurement data to geo-prediction server 103. As appropriate, geo-prediction server 103 predicts the upcoming route of client mobile device 105. Geo-prediction server 103 calculates what bit rate is available for client mobile device 105 as a function of time and/or location. Then, geo-prediction server 103 calculates a transmission policy based on knowledge of client buffering capabilities, and communicates that policy to client mobile device 105. Client mobile device 105 modifies its requests to streaming server 102 according to the received transmission policy. Then, streaming server 102 delivers content with the new streaming parameters to client mobile device 105.

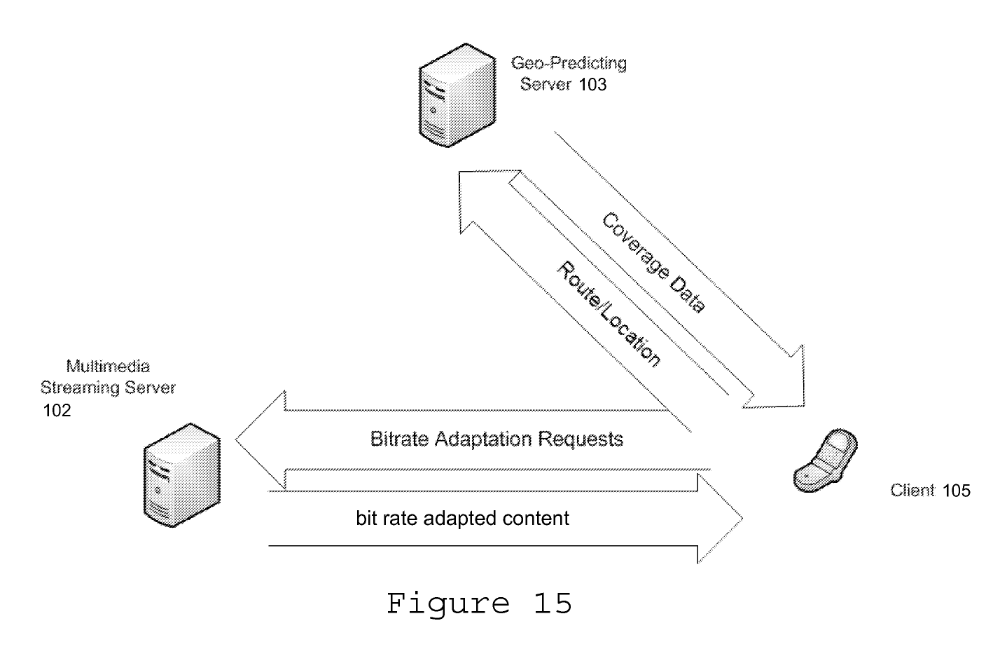

(3) In another example shown in FIG. 15, geo-prediction server 103 is connected to client mobile device 105, and client mobile device 105 handles adaptive bit rate control. In this example, client mobile device 105 sends its navigation route or segment thereof (or its current location) and associated measurement data to geo-prediction server 103. As appropriate, geo-prediction server 103 predicts the upcoming route of client mobile device 105. Geo-prediction server 103 sends coverage data for the route of client mobile device 105. Client 105 then modifies its requests to streaming server 102 according to that received coverage data, and then based on the new streaming parameters per the request, streaming server 102 delivers content to client mobile device 105.

What is claimed is:

1. A method, comprising:
sending content wirelessly to a client mobile device;
while the content is being wirelessly sent, determining that the client mobile device will enter a network outage region; and
modifying a bit rate of the wirelessly sent content responsive to the determining.

2. The method of claim 1, wherein the network outage region is a region in which a wireless signal carrying the sent content is reduced in quality.

3. The method of claim 1, wherein the network outage region is a region in which a wireless signal carrying the sent content is substantially nonexistent.

4. The method of claim 1, wherein the modifying comprises increasing a transmission bit rate of the sent content.

5. The method of claim 1, wherein the modifying comprises reducing an encoding bit rate of the sent content.

6. The method of claim 1, wherein the modifying comprises both increasing a transmission bit rate of the sent content and reducing an encoding bit rate of the sent content.

7. The method of claim 1, wherein the content comprises audio and video content.

8. The method of claim 1, further comprising:
receiving an indication of at least one of a location and a direction of the client mobile device,
wherein the determining comprises determining that the client mobile device will enter a network outage region based on the received indication of the at least one of the location and the direction.

9. The method of claim 8, wherein the determining further comprises determining that the client mobile device will enter a network outage region based on a comparison of the received indication of the at least one of the location and the direction, and stored data indicating a plurality of locations of network outage regions.

10. The method of claim 9, further comprising:
receiving from the client mobile device an indication of a quality of a wireless signal experienced by the client mobile device; and
associating the indication of the quality of the wireless signal with the indication of the at least one of the location and the direction of the client mobile device.

11. The method of claim 1, further comprising:
receiving coverage data associated with the client mobile device,
wherein the determining comprises determining that the client mobile device will enter a network outage region based on the received coverage data.

12. A computer-readable medium storing computer-executable instructions for performing a method, the method comprising:
sending content wirelessly to a client mobile device;
while the content is being wirelessly sent, determining that the client mobile device will enter a network outage region; and
modifying a bit rate of the wirelessly sent content responsive to the determining.

13. The computer-readable medium of claim 12, wherein the modifying comprises increasing a transmission bit rate of the sent content.

14. The computer-readable medium of claim 12, wherein the modifying comprises reducing an encoding bit rate of the sent content.

15. The computer-readable medium of claim 12, wherein the modifying comprises both increasing a transmission bit rate of the sent content and reducing an encoding bit rate of the sent content.

16. The computer-readable medium of claim 12, wherein the method further comprises:
receiving an indication of a location of the client mobile device,
wherein the determining comprises determining that the client mobile device will enter a network outage region based on the received indication of the location.

17. The computer-readable medium of claim 16, wherein the determining further comprises determining that the client mobile device will enter a network outage region based on a comparison of the received indication of the location and stored data indicating a plurality of locations of network outage regions.

18. A method, comprising:
receiving content wirelessly from a network at a client mobile device;
while the content is being wirelessly received, determining that the client mobile device will enter a network outage region; and
requesting the network to modify a bit rate of the content responsive to the determining.

19. The method of claim 18, wherein the requesting comprises requesting the network to increase a transmission bit rate of the content.

20. The method of claim 18, wherein the requesting comprises requesting the network to decrease an encoding bit rate of the content.

21. The method of claim 18, wherein the requesting comprises requesting the network to both increase a transmission bit rate of the content and decrease an encoding bit rate of the content.

22. The method of claim 18, further comprising:
determining a location of the client mobile device,
wherein the determining comprises determining that the client mobile device will enter a network outage region based on the received indication of the location.

23. The method of claim 22, wherein determining further comprises determining that the client mobile device will enter the network outage region based on a comparison of the determined location and stored data indicating a plurality of locations of network outage regions.

24. The method of claim 23, further comprising:
wirelessly sending to the network an indication of the determined location;
wirelessly receiving from the network data indicating the plurality of locations of the network outage regions; and
storing the received data as the stored data.

25. The method of claim 24, further comprising:
wirelessly sending to the network an indication of a quality of a wireless signal experienced by the client mobile device.

26. A computer-readable medium storing computer-executable instructions for performing a method, the method comprising:
receiving content wirelessly from a network at a client mobile device;
while the content is being wirelessly received, determining that the client mobile device will enter a network outage region; and
requesting the network to modify a bit rate of the content responsive to the determining.

27. The computer-readable medium of claim 26, wherein the requesting comprises requesting the network to increase a transmission bit rate of the content.

28. The computer-readable medium of claim 26, wherein the requesting comprises requesting the network to decrease an encoding bit rate of the content.

29. The computer-readable medium of claim 26, wherein the requesting comprises requesting the network to both increase a transmission bit rate of the content and decrease an encoding bit rate of the content.

30. The computer-readable medium of claim 26, further comprising:
determining a location of the client mobile device,
wherein the determining comprises determining that the client mobile device will enter a network outage region based on the received indication of the location.

31. The computer-readable medium of claim 30, wherein the determining further comprises determining that the client mobile device will enter the network outage region based on a comparison of the determined location and stored data indicating a plurality of locations of network outage regions.

32. An apparatus, comprising:
a processor configured to execute computer-readable instructions; and
a storage device coupled to the processor and storing the computer-executable instructions, wherein the computer-executable instructions are for:
sending content wirelessly to a client mobile device;
while the content is being wirelessly sent, determining that the client mobile device will enter a network outage region; and
modifying a bit rate of the wirelessly sent content responsive to the determining.

33. The apparatus of claim 32, wherein the modifying comprises increasing a transmission bit rate of the sent content.

34. An apparatus, comprising:
a processor configured to execute computer-readable instructions; and
a storage device coupled to the processor and storing the computer-executable instructions, wherein the computer-executable instructions are for:
while content is being wirelessly received from a network, determining that the apparatus will enter a network outage region; and
requesting the network to modify a bit rate of the content responsive to the determining.

35. The apparatus of claim 34, wherein the requesting comprises requesting the network to increase a transmission bit rate of the content.
